(19) United States
(12) Patent Application Publication
(10) Pub. No.: US 2025/0297135 A1
(43) Pub. Date: Sep. 25, 2025

(54) CERIA AND HYDROXAMIC ACID CMP COMPOSITION

(71) Applicant: ENTEGRIS, INC., Billerica, MA (US)

(72) Inventors: Alexander W. Hains, Aurora, IL (US); Steven Kraft, Aurora, IL (US); Juyeon Chang, Bolingbrook, IL (US); Douglas Robello, Aurora, IL (US)

(21) Appl. No.: 19/089,668

(22) Filed: Mar. 25, 2025

Related U.S. Application Data
(60) Provisional application No. 63/569,629, filed on Mar. 25, 2024.

(51) Int. Cl. C09G 1/02

(52) U.S. Cl. CPC C09G 1/02

(57) ABSTRACT

A chemical mechanical polishing composition comprises, consists of, or consists essentially of a liquid carrier, ceria particles dispersed in the liquid carrier; and a hydroxamic acid compound, wherein the hydroxamic compound comprises at least one of (i) a non-cyclic alkyl group having from three to ten carbon atoms, (ii) a halide-substituted phenyl group, (iii) a phenyl group or a substituted phenyl group and an alkyl linking group coupling the phenyl group or substituted phenyl group to a hydroxamic acid group, and (iv) a hydroxamic acid compound having a partition coefficient of at least about 0.9.

### BACKGROUND OF THE INVENTION

Chemical mechanical polishing (CMP) compositions and methods for polishing (or planarizing) the surface of a substrate are well known. Polishing compositions (also known as polishing slurries, CMP slurries, and CMP compositions) for polishing various dielectric layers (such as silicon oxide) on a semiconductor substrate may include abrasive particles (e.g., including ceria or silica particles) dispersed in an aqueous carrier and various chemical additives such as polishing rate accelerators and inhibitors, topography control agents, buffers, and the like.

CMP has long been employed to planarize dielectric layers. In example processes, dielectric material may be deposited over a structured substrate. Some amount of the resulting patterned dielectric may then be removed to planarize the substrate. Process metrics may include step height reduction, trench loss, and planarization efficiency as is known to those of ordinary skill in the art. With the introduction of 3D NAND applications and the continued device miniaturization there is a need for improved compositions capable of providing improved throughput, patterned removal rates, step height reduction, and/or planarization efficiency.

### BRIEF SUMMARY OF THE INVENTION

A chemical mechanical polishing composition is disclosed. The composition comprises, consists of, or consists essentially of a liquid carrier; ceria particles dispersed in the liquid carrier; and a hydroxamic acid compound. The hydroxamic compound comprises at least one of (i) a non-cyclic alkyl group having from three to ten carbon atoms, (ii) a halide-substituted or alkyl-substituted aryl group, (iii) an aryl group or a substituted aryl group and an alkyl linking group coupling the aryl group or substituted aryl group to a hydroxamic acid group, and (iv) a hydroxamic acid compound having a partition coefficient of at least about 0.9.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts structural formulas of example hydroxamic acid compounds in a first class of hydroxamic acid compounds.

FIG. 2 depicts structural formulas of example hydroxamic acid compounds in a second class of hydroxamic acid compounds.

FIG. 3 depicts structural formulas of example hydroxamic acid compounds in a third class of hydroxamic acid compounds.

FIG. 4 depicts structural formulas of comparative hydroxamic acid compounds (not in the first, second, or third classes depicted in FIGS. 1-3).

### DETAILED DESCRIPTION OF THE INVENTION

Chemical mechanical polishing compositions and methods for using those compositions to polish a substrate are disclosed. In one example embodiment, a chemical mechanical polishing composition comprises, consists essentially of, or consists of an aqueous-based liquid carrier; ceria particles dispersed in the liquid carrier; and a hydroxamic acid compound including a non-cyclic alkyl group having from three to ten carbon atoms (e.g., a straight-chain, saturated alkyl group having from 6 to 8 carbon atoms).

In another example embodiment, a chemical mechanical polishing composition comprises, consists essentially of, or consists of an aqueous-based liquid carrier; ceria particles dispersed in the liquid carrier; and a hydroxamic acid compound including a halide-substituted or alkyl-substituted aryl group (e.g., a fluoro- or methyl-substituted phenyl group).

In still another example embodiment, a chemical mechanical polishing composition comprises, consists essentially of, or consists of an aqueous-based liquid carrier; ceria particles dispersed in the liquid carrier; and a hydroxamic acid compound including an aryl group or a substituted aryl group and an alkyl linking group coupling the aryl group or substituted aryl group to a hydroxamic acid group (e.g., a phenyl group or substituted phenyl group and an alkyl linking group including 3 to 6 carbon atoms).

In yet another example embodiment, a chemical mechanical polishing composition comprises, consists essentially of, or consists of an aqueous-based liquid carrier; ceria particles dispersed in the liquid carrier; and a hydroxamic acid compound having a partition coefficient of at least about 0.9.

A method for polishing a dielectric-containing substrate includes contacting the substrate with one of the disclosed polishing compositions, moving the polishing composition relative to the substrate, and abrading the substrate to remove a portion of at least one dielectric layer (such as a silicon oxide-containing layer) from the substrate and thereby polish the substrate.

In example embodiments, disclosed polishing compositions may advantageously provide very high dielectric layer patterned wafer polishing rates and/or improved self-stopping performance (depending on the composition and the concentration of the hydroxamic acid). Without wishing to be bound by theory, it is believed that the disclosed hydroxamic acid compounds may function as highly effective polishing rate accelerators and self-stopping agents. The disclosed hydroxamic acid compounds may therefore facilitate a high pattern removal rate and depending on the concentration further facilitate transitioning from a high pattern removal rate to a relatively low blanket removal rate upon planarizing the substrate. Accordingly, the disclosed hydroxamic acid compounds may act as a rate enhancer at low concentrations and a self-stopping agent at comparatively higher concentrations.

The disclosed polishing compositions contain ceria particles in a liquid carrier (e.g., suspended or dispersed in the liquid carrier). Ceria particles suitable for polishing dielectric materials are well known in the CMP industry and are commercially available. The disclosed polishing compositions may contain substantially any suitable ceria particles, for example, including wet process ceria, precipitated ceria, fumed ceria, sintered (calcined) ceria, and/or condensation polymerized ceria particles. By ceria particles it is meant particles that are primarily or mostly ceria. Suitable ceria particles may also include doped ceria particles or ceria particles including small amounts (such as a few percent) of other elements or compounds, such as other oxides.

The ceria particles in the disclosed compositions may have substantially any particle size suitable for CMP operations. For example, the ceria particles may be characterized as having an average particle size (such as a weight average particle size or a number average particle size) greater than about 1 nm (e.g., greater than about 5 nm). Moreover, the ceria particles may be characterized as having an average particle size less than about 1 μm (e.g., less than about 500 nm). Accordingly, the ceria particles may be characterized as having an average particle size in a range from about 1 nm to about 1 μm (e.g., from about 5 nm to about 500 nm).

In preferred embodiments, the ceria particles may have an average particle size of about 20 nm or more (e.g., about 30 nm or more, about 40 nm or more, or about 50 nm or more). Alternatively, in preferred embodiments, the ceria particles may have an average particle size of about 400 nm or less (e.g., about 300 nm or less, about 200 nm or less, or about 150 nm or less). Accordingly, in such preferred embodiments, the ceria particles may have an average particle size within a range bounded by any two of the aforementioned endpoints. For example, the first ceria particles may have an average particle size of about 20 nm to about 400 nm (e.g., about 30 nm to about 300 nm, about 40 nm to about 200 nm, or about 50 nm to about 150 nm). In such embodiments, the ceria particle size may be as measured using a CPS Disc Centrifuge Particle size analyzer.

The ceria particles may be present in the polishing composition at any suitable concentration. A desired concentration of ceria particles may depend upon many factors, for example, including the desired dielectric removal rate and planarization efficiency, the size of the substrate (e.g., wafers) being polished, the type of polishing tool being utilized, and cost constraints. In example embodiments, the ceria particles may be present in the polishing composition at a concentration of about 0.01 wt. % or more at point of use (e.g., about 0.1 wt. % or more, about 0.2 wt. % or more, about 0.3 wt. % or more, or about 0.5 wt. % or more). Alternatively, or in addition, the first ceria particles may be present in the polishing composition at a concentration of about 10 wt. % or less at point of use (e.g., about 8 wt. % or less, about 6 wt. % or less, about 5 wt. % or less, or about 4 wt. % or less). Accordingly, the ceria particles may be present in the polishing composition at a concentration within a range bounded by any two of the aforementioned endpoints. For example, the first ceria particles may be present in the polishing composition at point of use at a concentration range from about 0.01 wt. % to about 10 wt. % (e.g., about 0.1 wt. % to about 5 wt. %).

In certain example embodiments, the disclosed polishing composition may include first ceria particles and second ceria particles. In such embodiments, the first ceria particles and the second ceria particles may include substantially any suitable ceria particles including, for example, fumed ceria particles, calcined ceria particles, or wet-process ceria particles. In some example embodiments, the first ceria particles may include calcined ceria particles, and the second ceria particles may include wet-process ceria particles. In embodiments including first and second ceria particles, the first ceria particles may be comparatively large and may have an average particle size of about 60 nm or greater (e.g., about 80 nm or greater, or about 100 nm or greater). Alternatively, or in addition, the first ceria particles may have an average particle size of about 400 nm or less (e.g., about 300 nm or less, or about 200 nm or less). Thus, the first ceria particles may have an average particle size within a range bounded by any two of the aforementioned endpoints. For example, the first ceria particles may have an average particle size of about 60 nm to about 400 nm (e.g., about 80 nm to about 300 nm or about 100 nm to about 200 nm).

Furthermore, in embodiments including first and second ceria particles, the second ceria particles may be comparatively small and may have an average particle size of about 20 nm or greater (e.g., about 30 nm or greater or about 40 nm or greater). Alternatively, or in addition, the second ceria particles may have an average particle size of about 80 nm or less (e.g., about 70 nm or less or about 60 nm or less). Accordingly, the second ceria particles may have an average particle size within a range bounded by any two of the aforementioned endpoints. For example, the second ceria particles may have an average particle size of about 10 nm to about 100 nm (e.g., about 20 nm to about 80 nm, about 30 nm to about 80 nm, about 30 nm to about 60 nm, or about 40 nm to about 60 nm). As noted above, the ceria particle size reported herein are weight average particle size as measured using a CPS Disc Centrifuge Particle size analyzer unless explicitly stated otherwise.

In embodiments including first and second ceria particles, the first and second ceria particles may be present in the polishing composition at any suitable concentrations to achieve the above listed total ceria amounts. The first and second ceria particles may be present in the polishing composition at any suitable weight ratio. The ratio of the second ceria particles to the first ceria particles may be greater than about 1:19 (e.g., greater than about 1:14, greater than about 1:12, greater than about 1:9, or greater than about 1:4). Alternatively, or in addition, the ratio of the second ceria particles to the first ceria particles may be less than about 1:2 (e.g., less than about 1:1, less than about 3:4, less than about 2:3, or less than about 3:7). Accordingly, the ratio of the second ceria particles to the first ceria particles may be within a range bounded by any two of the aforementioned endpoints. For example, the ratio of the second ceria particles to the first ceria particles may be in a range from about 1:19 to about 2:1 (e.g., from about 1:14 to about 1:1 or from about 1:9 to about 2:3). In preferred embodiments that include first ceria particles and second ceria particles, the ratio of the second ceria particles to the first ceria particles may be in a range from about 1:4 to about 3:7.

It will be appreciated that embodiments including first ceria particles and second ceria particles may further include third ceria particles (e.g., third ceria particles, fourth ceria particles, and so on) and/or other non-ceria particles (such as silica particles, alumina particles, and/or zirconia particles). Such third ceria particles and/or other non-ceria particles may have any suitable particle size and surface area and may be present in the polishing composition at any suitable concentration. The disclosed embodiments are expressly not limited to polishing compositions including only first ceria particles and second ceria particles.

A liquid carrier is generally used to facilitate the application of the ceria particles and any optional chemical additives to the surface of the substrate to be polished. The liquid carrier may include any suitable carrier (e.g., a solvent) including lower alcohols (e.g., methanol, ethanol, etc.), ethers (e.g., dioxane, tetrahydrofuran, etc.), water, and mixtures thereof. Preferably, the liquid carrier comprises, consists essentially of, or consists of water, more preferably deionized water.

The disclosed polishing compositions further include a hydroxamic acid compound as described in more detail below. A hydroxamic acid or substituted hydroxamic acid compound may be described by the following formula:

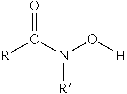

in which R and R′ are one or more selected from the group consisting of: hydrogen, alkyl, cycloalkyl, heterocyclic alkyl, aryl, and heterocyclic aryl, any of which may be substituted. In preferred embodiments, R′ is hydrogen.

The disclosed polishing compositions may include one or more of the first, the second, and/or the third class of hydroxamic acid compounds described below (e.g., a single compound or a mixture of compounds from the same or different classes). In the first class of hydroxamic acid compounds, R comprises or consists of a non-cyclic alkyl group having from three to ten carbon atoms. The term “alkyl” as used herein allows for branching and straight-chain groups, and generally refers to a saturated group (e.g., —CₙH₂ₙ₊) but does allow for a small degree of unsaturation, e.g., one carbon-carbon double bond or two carbon-carbon double bonds. In preferred embodiments of this first class of hydroxamic acid compounds, R is a straight-chain, saturated alkyl group including from four to ten carbon atoms. In most preferred embodiments, R includes from six to ten carbon atoms (e.g., from six to nine carbon atoms or from six to eight carbon atoms). Most preferred hydroxamic acid compounds in the first class of hydroxamic acid compounds include hexanohydroxamic acid (HexHA), heptanohydroxamic acid (HeptHA), octanohydroxamic acid (OctHA), nonanohydroxamic acid (NonHA), and decanohydroxamic acid (DecHA).

In the second class of hydroxamic acid compounds, R comprises or consists of a halide- or alkyl-substituted aryl group, for example, a fluoro-substituted aryl group or methyl-substituted aryl group. By “halide-substituted” it is meant that a carbon-bonded hydrogen in the aryl group is replaced by a halide atom. By “alkyl-substituted” it is meant that a carbon-bonded hydrogen in the aryl group is replaced by an alkyl group such as a methyl, ethyl, or propyl group. In preferred embodiments, the aryl group is a phenyl group. In the second class of hydroxamic acid compounds, the halide- or alkyl-substituted aryl group may be coupled directly to the hydroxamic acid group or may be coupled to the hydroxamic acid group via an alkyl linking group (such as an ethyl, propyl, butyl, pentyl, or hexyl group). In preferred embodiments of the second class of hydroxamic acid compounds, R comprises or consists of a fluoro-substituted phenyl group or a methyl-substituted phenyl group. In such preferred embodiments, the fluorine atom or alkyl group may be substituted at the second, third, or fourth position on the phenyl group. The disclosed embodiments are not limited in regard to the substitution position. Most preferred hydroxamic acid compounds in the second class of hydroxamic acid compounds include fluorobenzo hydroxamic acid (2FBHA, 3FBHA, or 4FBHA) and methylbenzo hydroxamic acid (2MeBHA, 3MeBHA, or 4MeBHA).

In the third class of hydroxamic acid compounds, R comprises or consists of an aryl group or a substituted aryl group and an alkyl linking group coupling the aryl group or substituted aryl group to a hydroxamic acid group. In preferred embodiments of the third class of hydroxamic acid compounds, the alkyl linking group may be a straight chain alkyl group containing from three to eight carbon atoms (e.g., from three to six carbon atoms). The most preferred alkyl linking groups include propyl, butyl, pentyl, and hexyl. In preferred embodiments of the third class of hydroxamic acid compounds, the aryl group is a non-substituted phenyl group, a halide-substituted phenyl group (e.g., a fluoro-substituted phenyl group as described above), or an alkyl or alkoky-substituted phenyl group (such as methyl or methoxy-substituted). Most preferred hydroxamic acid compounds in the third class include 4-phenylbutyrl hydroxamic acid (4PhBuHA), 4-(p-anisyl) butyrohydroxamic acid (4pAnisBuHA), 4-(p-tolyl) butyrohydroxamic acid (4pTolBuHA), cinnamohydroxamic acid (CinHA), and mixtures thereof.

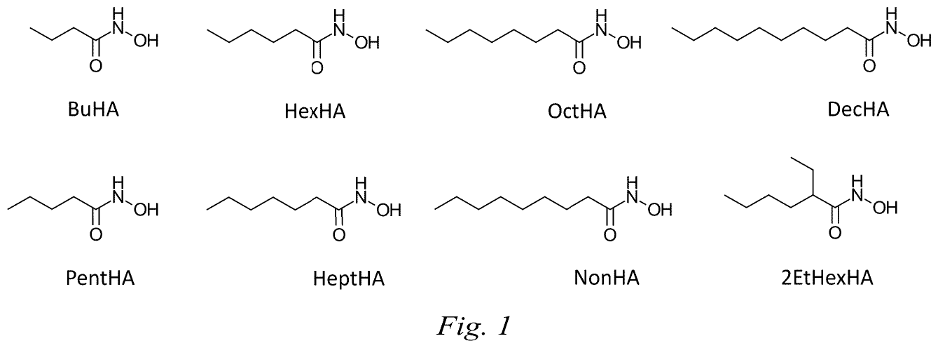

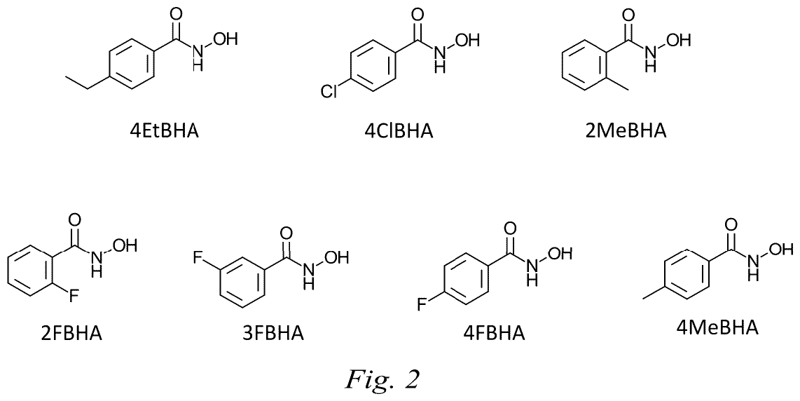

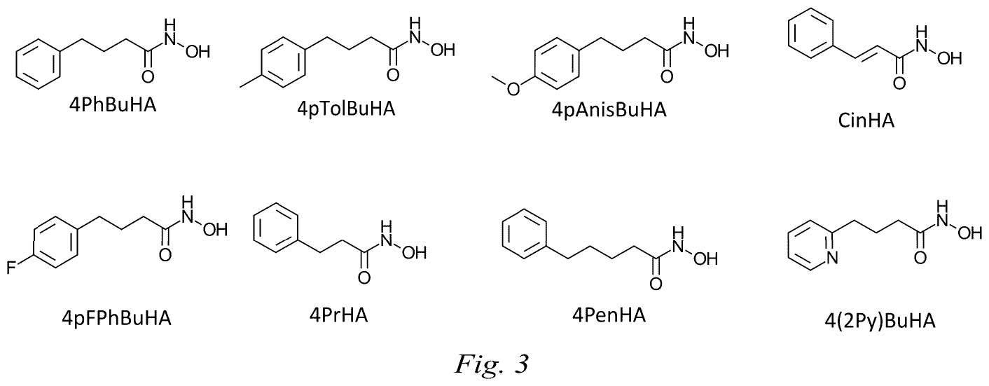

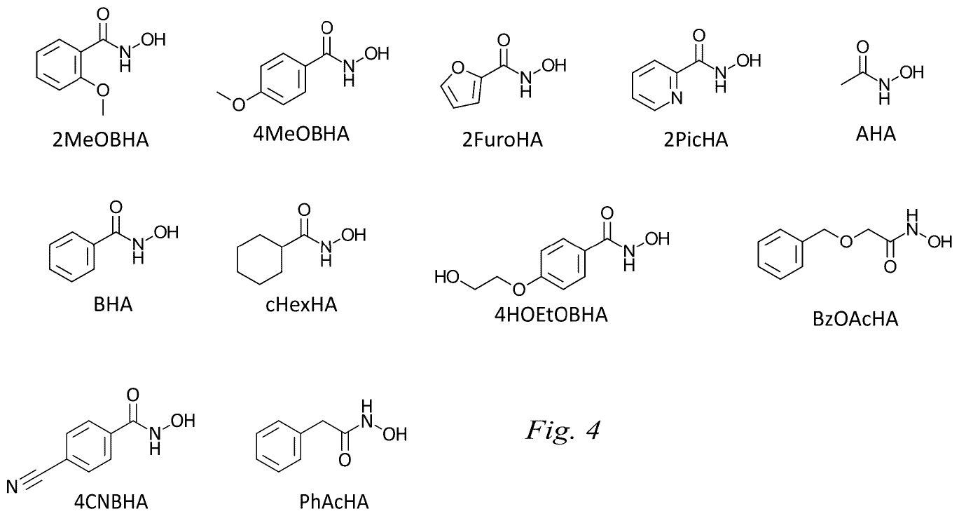

FIG. 1 depicts structural formulas of example hydroxamic acid compounds in the first class. FIG. 2 depicts structural formulas of example hydroxamic acid compounds in the second class. FIG. 3 depicts structural formulas of example hydroxamic acid compounds in the third class. FIG. 4 depicts structural formulas of comparative hydroxamic acid compounds (not in the first, second, or third class as defined above).

It will be appreciated that the disclosed embodiments are not necessarily limited to polishing compositions including a hydroxamic acid compound selected from one of the first, second, and/or third classes described above. The disclosed polishing compositions may include substantially any suitable hydrophobic hydroxamic acid compound (including those in the first, second, and/or third classes) having a partition coefficient that is greater than or equal to a threshold value. As known to those of skill in the chemical arts, the partition coefficient is a measure of the hydrophilicity or hydrophobicity of a chemical compound, such as hydroxamic acid (with a positive partition coefficient indicating a hydrophobic compound). In particular, the partition coefficient is a ratio of concentrations of the chemical compound in a mixture of two immiscible solvents at equilibrium. For the purposes of this disclosure (and as used herein), the partition coefficient is the ratio of the concentration of the hydroxamic acid compound in octanol to the concentration of the hydroxamic acid in water as follows:

$$log P = {log}_{10} ( \frac{{[ HA ]}_{octanol}}{{[ HA ]}_{water}} )$$

where log P represents the partition coefficient and [HA]_{octanol} and [HA]_{water} represent the concentrations of the hydroxamic acid compound HA in octanol and water. It will be appreciated, that the partition coefficient of a chemical compound, such as a hydroxamic acid compound, may be measured or it may be calculated based on the molecular structure of the compound. In certain preferred embodiments, the polishing composition includes a hydroxamic acid compound that has a partition coefficient of at least 0.9. In more preferred embodiments, the polishing composition includes a hydroxamic acid compound that has a partition coefficient of at least 1.2. In most preferred embodiments, the polishing composition includes a hydroxamic acid compound that has a partition coefficient of at least 1.4.

In example polishing compositions that make use of a water based or aqueous liquid carrier, such as deionized water, the hydroxamic acid compound may further advantageously have a suitably high solubility in water. It will be appreciated that higher solubilities enable higher concentrations of the hydroxamic acid compound to be utilized and may therefore enable slurry concentrates to be formulated. However, the disclosed compositions are not necessarily limited in this regard as there are known methods for solubilizing substantially insoluble compounds. Notwithstanding the foregoing, the disclosed polishing compositions may advantageously include a hydroxamic acid compound having an aqueous solubility of at least about 0.1% (e.g., at least about 0.2%, at least about 0.3%, at least about 0.5%, or even at least about 1%).

In certain advantageous embodiments, the disclosed polishing compositions may include a hydroxamic acid compound having a partition coefficient of at least 0.9 and an aqueous solubility of at least about 0.1% (e.g., at least about 0.3% or at least about 0.5%). In most preferred embodiments, the disclosed polishing compositions may include a hydroxamic acid compound having a partition coefficient of at least 1.2 and an aqueous solubility of at least about 0.5% (e.g., at least about 1%).

The disclosed polishing compositions may include substantially any suitable amount of the hydroxamic acid. For example, the polishing composition may include 1 ppm by weight (0.0001 wt. %) or more of the hydroxamic acid compound at point of use (e.g., 5 ppm or more, 10 ppm or more, 20 ppm or more, 50 ppm or more, 100 ppm or more, or 200 ppm or more). Alternatively, or in addition, the polishing composition may include 2 wt. % (20,000 ppm) or less of the hydroxamic acid compound at point of use (e.g., 1 wt. % or less, 5000 ppm or less, 2000 ppm or less, 1500 ppm or less, 1000 ppm or less, 750 ppm or less, or 500 ppm or less). Accordingly, the polishing composition may include from about 1 ppm by weight to about 20,000 ppm by weight of the hydroxamic acid compound at point of use (e.g., from about 1 ppm to about 5000 ppm, from about 10 ppm to about 2000 ppm, or from about 20 ppm to about 1000 ppm).

It has been found that the preferred amount of hydroxamic acid compound may depend on the size of the substrate to be polished and/or on the amount of ceria present in the composition. For example, for applications in which 200 mm wafers are polished and the composition includes about 0.1 wt. % to about 2 wt. % ceria particles, the preferred amount of hydroxamic acid compound may be from about 50 ppm to about 500 ppm by weight. For applications in which 300 mm wafers are polished and the composition includes about 0.5 wt. % to about 10 wt. % ceria particles, the preferred amount of hydroxamic acid compound may be from about 200 ppm to about 2000 ppm by weight.

The polishing composition may optionally include other chemical materials, additives, or minor ingredients such as a polishing rate enhancer or accelerator, a polymer, surfactant, a catalyst, an inhibitor, a pH-adjuster and/or buffer, and a biocide, among others. The disclosed embodiments are not limited to including or not including any of such minor ingredients.

In example embodiments, the polishing composition may further include a rate enhancer such as an organic carboxylic acid or a functionalized nitrogen-containing heterocycle that activates the ceria particles or the substrate by forming hypercoordinate compounds (e.g., pentacoordinate or hexacoordinate silicon compounds). Preferred rate enhancers may include, for example, picolinic acid, acetic acid, 4-hydroxybenzoic acid, quinaldic acid, and combinations thereof. Picolinic acid is the most preferred rate enhancer for certain example CMP applications. The rate enhancer may be present in the composition in substantially any suitable amount, for example, from about 10 ppm by weight to about 1500 ppm by weight (e.g., from about 100 ppm to about 1000 ppm).

In example embodiments, the polishing composition may optionally further include a cationic compound such as a cationic polymer or a cationic surfactant. The cationic compound may function, for example, as a planarizing agent or a topography control agent to improve the topography of the polished substrate. A cationic polymer may include substantially any suitable cationic polymer, for example, a cationic homopolymer, a cationic copolymer including at least one cationic monomer (and an optional nonionic monomer), and combinations thereof.

The cationic polymer may be substantially any suitable cationic homopolymer including cationic monomer repeat units, for example, including quaternary amine groups as repeat units. The quaternized amine groups may be acyclic or incorporated into a ring structure. Quaternized amine groups include tetrasubstituted nitrogen atoms substituted with four groups independently selected from alkyl, alkenyl, aryl, arylalkyl, acrylamido, or methacrylate groups. When included into a ring structure, quaternized amine groups include either a heterocyclic saturated ring including a nitrogen atom and are further substituted with two groups as described above or a heteroaryl group (e.g., imidazole or pyridine) having a further group as described above bonded to the nitrogen atom. Quaternized amine groups possess a positive charge (i.e., are cations having associated anionic moieties, thereby forming salts). It is also suitable for the cationic polymer to be further modified by alkylation, acylation, ethoxylation, or other chemical reaction, in order to alter the solubility, viscosity, or other physical parameter of the cationic polymer. Suitable quaternary amine monomers include, for example, quaternized vinylimidazole (vinylimidazolium), methacryloyloxyethyltrimethylammonium halide (MADQUAT), diallyldimethylammonium halide (DADMAC), methacrylamidopropyl trimethylammonium halide (MAPTAC), epichlorohydrin-dimethylamine (epi-DMA), cationic poly(vinyl alcohol) (PVOH), quaternized hydroxyethylcellulose, and combinations thereof.

The cationic polymer may also be a copolymer including at least one cationic monomer (e.g., as described in the preceding paragraph) and at least one nonionic monomer. Non-limiting examples of suitable nonionic monomers include vinylpyrrolidone, vinylcaprolactam, vinylimidazole, acrylamide, vinyl alcohol, polyvinyl formal, polyvinyl butyral, poly(vinyl phenyl ketone), vinylpyridine, polyacrolein, cellulose, hydroxylethyl cellulose, ethylene, propylene, styrene, and combinations thereof.

Example cationic polymers include but are not limited to poly(vinylimidazolium), poly(methacryloyloxyethyltrimethylammonium) chloride (polyMADQUAT), poly(diallyldimethylammonium) chloride (polyDADMAC) (i.e., Polyquaternium-6), poly(dimethylamine-co-epichlorohydrin), poly[bis(2-chloroethyl) ether-alt-1,3-bis[3-(dimethylamino)propyl]urea] (i.e., Polyquaternium-2), copolymers of hydroxyethyl cellulose and diallyldimethylammonium (i.e., Polyquaternium-4), copolymers of acrylamide and diallyldimethylammonium (i.e., Polyquaternium-7), quaternized hydroxyethylcellulose ethoxylate (i.e., Polyquaternium-10), copolymers of vinylpyrrolidone and quaternized dimethylaminocthyl methacrylate (i.e., Polyquatemium-11), copolymers of vinylpyrrolidone and quaternized vinylimidazole (i.e., Polyquatemium-16), Polyquaternium-24, a terpolymer of vinylcaprolactam, vinylpyrrolidone, and quaternized vinylimidazole (i.e., Polyquaternium-46), 3-Methyl-1-vinylimidazolium methyl sulfate-N-vinylpyrrolidone copolymer (i.e., Polyquaternium-44), and copolymers of vinylpyrrolidone and diallyldimethylammonium. Additionally, suitable cationic polymers include cationic polymers for personal care such as Luviquat® Supreme, Luviquat® Hold, Luviquat® UltraCare, Luviquat® FC 370, Luviquat® FC 550, Luviquat® FC 552, Luviquat® Excellence, GOHSEFIMER K210™, GOHSENX K-434, and combinations thereof.

In certain embodiments, the cationic polymer may include an amino acid monomer (such compounds may also be referred to as polyamino acid compounds). Suitable polyamino acid compounds may include substantially any suitable amino acid monomer groups, for example, including polyarginine, polyhistidine, polyalanine, polyglycine, polytyrosine, polyproline, and polylysine. In certain embodiments, polylysine is a preferred polyamino acid. It will be understood that polylysine may include ε-polylysine and/or α-polylysine composed of D-lysine and/or L-lysine. The polylysine may thus include α-poly-L-lysine, α-poly-D-lysine, ε-poly-L-lysine, ε-poly-D-lysine, and mixtures thereof. In certain embodiments, the polylysine may be ε-poly-L-lysine. It will further be understood that the polyamino acid compound (or compounds) may be used in any accessible form, e.g., the conjugate acid or base and salt forms of the polyamino acid may be used instead of (or in addition to) the polyamino acid.

The optional cationic compound (such as a cationic polymer) may be present at substantially any suitable level, for example, from about 0 ppm to about 500 ppm by weight (e.g., from about 0 ppm to about 100 ppm, from about 0 ppm to about 20 ppm, or from about 1 ppm to about 10 ppm). Moreover, optional cationic polymers may have substantially any suitable molecular weight, for example, from about 200 g/mol to about 1,000,000 g/mol (e.g., from about 1,000 g/mol to about 500,000 g/mol, or from about 2,000 g/mol to about 100,000 g/mol).

In an example embodiment, the polishing composition may alternatively and/or additionally include a nonionic or anionic compound such as a nonionic polymer, and anionic polymer, a nonionic surfactant, and amphoteric surfactant, or an anionic surfactant. An anionic polymer may include, for example, a carboxylic acid monomer, a sulfonated monomer, or a phosphonated monomer, and an acrylate, a polyvinylpyrrolidone, or a polyvinylalcohol. A nonionic polymer may include, for example, polyvinylpyrrolidone or polyethylene glycol. Such nonionic or anionic compounds may be present at substantially any suitable level, for example, from about 0 ppm to about 500 ppm by weight (e.g., from about 0 ppm to about 100 ppm, from about 0 ppm to about 20 ppm, or from about 1 ppm to about 10 ppm).

The polishing composition may have substantially any suitable pH at point of use. For example, the polishing composition may have a pH of about 2 or more (e.g., about 3 or more, about 3.5 or more, or about 4 or more). Moreover, the polishing composition may have a pH of about 9 or less (e.g., about 8 or less, about 7 or less, about 6.5 or less, or about 6 or less). Accordingly, the polishing composition may have a pH in a range bounded by any two of the aforementioned endpoints, for example, in a range from about 2 to about 9 (e.g., from about 3 to about 8, from about 3.5 to about 6.5, or from about 4 to about 6). It will be appreciated that in example embodiments the polishing composition may be provided as a two-package system, for example, a first package including the ceria particles and a second package including the hydroxamic acid compound. In such embodiments, the pH of each package may be in any of the above-described ranges.

The pH of the polishing composition (or of the first package or the second package in a two-package system) may be achieved and/or maintained by any suitable means. The polishing composition may include substantially any suitable pH adjusting agents or buffering systems. For example, suitable acidic pH adjusting agents may include nitric acid, sulfuric acid, phosphoric acid, phthalic acid, citric acid, adipic acid, oxalic acid, malonic acid, maleic acid, acetic acid, and the like. Suitable basic pH adjusting agents may include potassium hydroxide, ammonium hydroxide, alkyl ammonium hydroxides, such as tetrabutylammonium hydroxide, and the like. Suitable buffering agents may include phosphates, sulfates, acetates, malonates, oxalates, borates, ammonium salts, triethanolamine, tris family buffers, and the like.

While example embodiments of the disclosed polishing composition may be supplied as a one-package system, the polishing composition may be advantageously provided as a two-package system. For example, the disclosed polishing composition may be supplied as a first package including the ceria particles (such as the first ceria particles and the second ceria particles) and a second package including the hydroxamic acid compound. The first and second packages may be combined, e.g., by the end-user, on the polishing pad (e.g., via in-line mixing) or shortly before use (e.g., 1 week or less prior to use, 1 day or less prior to use, 1 hour or less prior to use, 10 minutes or less prior to use, or 1 minute or less prior to use).

The disclosed polishing compositions may also be provided as a concentrate which is intended to be diluted with an appropriate amount of water prior to use. In such concentrated embodiments, the polishing composition concentrate may include the ceria particles, the hydroxamic acid compound, water, and other optional components, such as a biocide, in amounts such that, upon dilution of the concentrate with an appropriate amount of water, each component of the polishing composition will be present in the polishing composition in an amount within the appropriate ranges recited above for each component. For example, the ceria particles, the hydroxamic acid compound, and other optional components may each be present in the polishing composition in an amount that is about 2 times (e.g., about 3 times, about 4 times, about 5 times, or even up to about 8 times) greater than the point of use concentrations recited above for each component so that, when the concentrate is diluted with an equal volume of (e.g., 2 equal volumes of water, 3 equal volumes of water, 4 equal volumes of water, or 7 equal volumes of water) each component will be present in the polishing composition in an amount within the ranges set forth above for each component. In example compositions that are supplied as a two-package system, it will be appreciated that either one or both of the packages may also optionally be supplied as a concentrate with appropriate amounts of each component such that upon dilution and combining the two packages each component will be present in the polishing composition in an amount within the ranges set forth above.

The disclosed polishing compositions may be used to polish substantially any substrate, for example, including a dielectric layer such as a silicon oxide layer. Certain advantageous embodiments may be particularly useful in the polishing of a substrate including a patterned silicon oxide layer such as those employed in 3D NAND devices. The polishing method of the invention is particularly suited for use in conjunction with a chemical mechanical polishing (CMP) apparatus. Typically, the apparatus includes a platen, which, when in use, is in motion and has a velocity that results from orbital, linear, or circular motion, a polishing pad in contact with the platen and moving with the platen when in motion, and a carrier that holds a substrate to be polished by contacting and moving relative to the surface of the polishing pad. The polishing of the substrate takes place by the substrate being placed in contact with the polishing pad and the polishing composition of the invention and then the polishing pad moving relative to the substrate, so as to abrade at least a portion of the substrate (such as a silicon oxide dielectric material as described herein) to polish the substrate.

A substrate may be planarized or polished with the chemical mechanical polishing composition with any suitable polishing pad (e.g., polishing surface). Suitable polishing pads include, for example, woven and non-woven polishing pads. Moreover, suitable polishing pads may comprise any suitable polymer of varying density, hardness, thickness, compressibility, ability to rebound upon compression, and compression modulus. Suitable polymers include, for example, polyvinylchloride, polyvinylfluoride, nylon, fluorocarbon, polycarbonate, polyester, polyacrylate, polyether, polyethylene, polyamide, polyurethane, polystyrene, polypropylene, co-formed products thereof, and mixtures thereof.

The following examples further illustrate the invention but, of course, should not be construed as in any way limiting its scope.

### Example 1

Nine polishing compositions were prepared. Each of the polishing compositions included 0.5 weight percent of an 80:20 blend (by weight) of a first ceria having a weight average particle size of 128 nm (measured via CPS) and a surface area of 14 m²/g and a second ceria having a weight average particle size of 47 nm (measured via CPS) and a surface area of 168 m²/g. Polishing composition 1A did not include a hydroxamic acid polishing rate accelerator. Polishing compositions 1B, 1D, 1F, and 1H, included 0.73 mM of a hydroxamic acid polishing rate accelerator. And polishing compositions 1C, 1E, 1G, and 1I included 1.46 mM of the hydroxamic acid polishing rate accelerator. The amount and type of each hydroxamic acid are listed in Table 1A (see also FIGS. 1-4). The pH of each composition was about 5.5.

The CMP performance of each of the polishing compositions was evaluated using a Mirra® CMP polishing tool (Applied Materials) with an E6088 polishing pad (Entegris) and in-situ conditioning using a Saesol DS8051 disk conditioner at 6 lbs. Polishing removal rates were obtained by polishing 200 mm blanket and patterned TEOS wafers at a downforce of 3.0 psi, a platen speed of 100 rpm, a head speed of 85 rpm, and a slurry flow rate was 150 mL/min. Blanket wafer and patterned wafer polishing rates are shown in Table 1B. The patterned wafer rates are reported for a 900×900 μm line feature.

TABLE 1A

| Polishing Composition | Hydroxamic Acid | Concentration (mM) |
|---|---|---|
| 1A | — | — |
| 1B | BHA | 0.73 |
| 1C | BHA | 1.46 |
| 1D | 2PicHA | 0.73 |
| 1E | 2PicHA | 1.46 |
| 1F | HexHA | 0.73 |
| 1G | HexHA | 1.46 |
| 1H | OctHA | 0.73 |
| 1I | OctHA | 1.46 |

TABLE 1B

| Polishing Composition | Blanket Rate (Å/min) | Pattern Rate (Å/min) |
|---|---|---|
| 1A | 9756 | 5862 |
| 1B | 10,507 | 9965 |
| 1C | 10,564 | 11,017 |
| 1D | 9916 | 6357 |
| 1E | 8617 | 7132 |
| 1F | 10,275 | 10,948 |
| 1G | 10,014 | 11,496 |
| 1H | 10,003 | 11,551 |
| 1I | 5,337 | 11,637 |

As is evident from the data set forth in table 1B, polishing compositions 1F and 1G including the HexHA and polishing compositions 1H and 1I including OctHA achieved improved pattern removal rates. Note that the patterned removal rate was greater than the blanket removal rate for each of these compositions indicating the improved performance of alkyl hydroxamic acid compounds having six or more carbon atoms.

### Example 2

Nine polishing compositions were prepared. Each of the polishing compositions included 0.5 weight percent of an 80:20 blend (by weight) of a first ceria having a weight average particle size of 128 nm (measured via CPS) and a surface area of 14 m²/g and a second ceria having a weight average particle size of 47 nm (measured via CPS) and a surface area of 168 m²/g. Polishing composition 2A did not include a hydroxamic acid polishing rate accelerator. Polishing compositions 2B, 2D, 2F, and 2H included 0.73 mM of a hydroxamic acid polishing rate accelerator. And polishing compositions 2C, 2E, 2G, and 2I included 1.46 mM of the hydroxamic acid polishing rate accelerator. The amount and type of each hydroxamic acid are listed in Table 2A (see also FIGS. 1-4). The pH of each composition was about 5.5.

The CMP performance of each of the polishing compositions was evaluated using a Mirra® CMP polishing tool (Applied Materials) with an E6088 polishing pad (Entegris) and in-situ conditioning using a Saesol DS8051 disk conditioner at 6 lbs. Polishing removal rates were obtained by polishing 200 mm blanket and patterned TEOS wafers at a downforce of 3.0 psi, a platen speed of 100 rpm, a head speed of 85 rpm, and a slurry flow rate was 150 mL/min. Blanket wafer and patterned wafer polishing rates are shown in Table 2B. The patterned wafer rates are reported for a 900×900 μm line feature.

TABLE 2A

| Polishing Composition | Hydroxamic Acid | Concentration (mM) |
|---|---|---|
| 2A | — | — |
| 2B | BHA | 0.73 |
| 2C | BHA | 1.46 |
| 2D | 4FBHA | 0.73 |
| 2E | 4FBHA | 1.46 |
| 2F | 2MeBHA | 0.73 |
| 2G | 2MeBHA | 1.46 |
| 2H | 2MeOBHA | 0.73 |
| 2I | 2MeOBHA | 1.46 |

TABLE 2B

| Polishing Composition | Blanket Rate (Å/min) | Pattern Rate (Å/min) |
|---|---|---|
| 2A | 9756 | 5862 |
| 2B | 10,507 | 9965 |
| 2C | 10,564 | 11,017 |
| 2D | 10,408 | 9,776 |
| 2E | 9,776 | 10,436 |
| 2F | 10,521 | 10,820 |
| 2G | 10,395 | 11,344 |
| 2H | 10,411 | 9,277 |
| 2I | 9,009 | 8,973 |

As is evident from the data set forth in table 2B, polishing compositions 2F and 2G including the 2MeBHA improved the pattern removal rate. Compositions 2D and 2E including the 4FBHA also achieved high pattern removal rates indicating the improved performance of alkyl-(methyl- and halide-(fluorine-) substituted aryl hydroxamic acid compounds.

### Example 3

Nine polishing compositions were prepared. Each of the polishing compositions included 0.5 weight percent of an 80:20 blend (by weight) of a first ceria having a weight average particle size of 128 nm (measured via CPS) and a surface area of 14 m²/g and a second ceria having a weight average particle size of 47 nm (measured via CPS) and a surface area of 168 m²/g. Polishing composition 3A did not include a hydroxamic acid polishing rate accelerator. Polishing compositions 3B, 3D, 3F, 3G, and 3H included 0.73 mM of the hydroxamic acid polishing rate accelerator. Polishing compositions 3C and 3E included 1.46 mM of the hydroxamic acid polishing rate accelerator. And polishing composition 31 included 0.54 mM of the hydroxamic acid polishing rate accelerator (owing to solubility limitations). The amount and type of each hydroxamic acid are listed in Table 3A (see also FIGS. 1-4). The pH of each composition was about 5.5.

The CMP performance of each of the polishing compositions was evaluated using a Mirra® CMP polishing tool (Applied Materials) with an E6088 polishing pad (Entegris) and in-situ conditioning using a Saesol DS8051 disk conditioner at 6 lbs. Polishing removal rates were obtained by polishing 200 mm blanket and patterned TEOS wafers at a downforce of 3.0 psi, a platen speed of 100 rpm, a head speed of 85 rpm, and a slurry flow rate was 150 mL/min. Blanket wafer and patterned wafer polishing rates are shown in Table 3B. The patterned wafer rates are reported for a 900×900 μm line feature.

TABLE 3A

| Polishing Composition | Hydroxamic Acid | Concentration (mM) |
|---|---|---|
| 3A | — | — |
| 3B | BHA | 0.73 |
| 3C | BHA | 1.46 |
| 3D | 4PhBuHa | 0.73 |
| 3E | 4PhBuHa | 1.46 |
| 3F | 4pAnisBuHA | 0.73 |
| 3G | 4pTolBuHA | 0.73 |
| 3H | CinHA | 0.73 |
| 3I | BzOAcHA | 0.54 |

TABLE 3B

| Polishing Composition | Blanket Rate (Å/min) | Pattern Rate (Å/min) |
|---|---|---|
| 3A | 9756 | 5862 |
| 3B | 10,507 | 9965 |
| 3C | 10,564 | 11,017 |
| 3D | 10,267 | 11,899 |
| 3E | 8735 | 12,429 |
| 3F | 10,346 | 11,975 |
| 3G | 9874 | 12,809 |
| 3H | 11,087 | 11,883 |
| 3I | 10,321 | 10,770 |

As is evident from the data set forth in table 3B, polishing compositions 3D through 3H achieved significantly improved pattern removal rates. Note that the patterned removal rate was significantly greater than the blanket removal rate for each composition indicating the improved performance of hydroxamic acid compounds including an aryl group or a substituted aryl group and an alkyl linking group coupling the aryl group or substituted aryl group to the hydroxamic acid group.

### Example 4

Thirty polishing compositions were prepared using 10 distinct hydroxamic acid compounds. Each of the polishing compositions was prepared as an A pack and a corresponding B pack. The A packs included 0.43 weight percent of a ceria having a substantially cubic shape, a weight average particle size of 136 nm (measured via CPS), and a surface area of 13 m²/g. The A pack further included 3500 ppm by weight picolinic acid and had a pH of 4. The B pack included a hydroxamic acid compound (at 1000, 2000, or 3000 ppm by weight) and a sufficient quantity of a bis-tris buffer to buffer the pH of the B pack at pH 7. The hydroxamic acid compounds are listed in Table 4A (see also FIGS. 1-4). The A pack and B pack were mixed at a 7:3 ratio prior to polishing (such that the polishing compositions included 300, 600, or 900 ppm by weight of the corresponding hydroxamic acid compound).

The CMP performance of each polishing compositions was evaluated using a Mirra® CMP polishing tool (Applied Materials) with an E6088 polishing pad (Entegris) and in-situ conditioning using a Saesol DS8051 disk conditioner at 6 lbs. Polishing removal rates were obtained by polishing 200 mm blanket wafers at a downforce of 3.0 psi, a platen speed of 100 rpm, a head speed of 85 rpm, and a slurry flow rate was 150 mL/min. Blanket wafer polishing rates are shown in Table 4B.

TABLE 4A

| Polishing Compositions | Hydroxamic Acid |
|---|---|
| 4A | BHA |
| 4B | 2MeOBHA |
| 4C | 4MeOBHA |
| 4D | 2PicHA |
| 4E | 4FBHA |
| 4F | 4PhBuHA |
| 4G | 2FuroHA |
| 4H | 4HOEtOBHA |
| 4I | PhAcHA |
| 4J | cHexHA |

TABLE 4B

| | Blanket Rate | Blanket Rate | Blanket Rate |
|---|---|---|---|
| Polishing | (Å/min) | (Å/min) | (Å/min) |
| Compositions | 300 ppm HA | 600 ppm HA | 900 ppm HA |
| 4A | 3404 | 1517 | 781 |
| 4B | 3165 | 1948 | 613 |
| 4C | 2676 | 1316 | 775 |
| 4D | 3664 | 2067 | 1156 |
| 4E | 1792 | 724 | 469 |
| 4F | 844 | 366 | 238 |
| 4G | 4270 | 2801 | 1607 |
| 4H | 4985 | NA | 3984 |
| 4I | 3333 | 2375 | 1287 |
| 4J | 3963 | 3650 | 2788 |

As is apparent from the results set forth in table 4B, polishing compositions 4E and 4F achieved superior self-stopping performance (as indicated by the lower polishing rates on the blanket wafers). This example demonstrates the superiority of compositions in which the hydroxamic acid includes a substituted aryl group (a fluoro-substituted phenyl group in this example) or an aryl group and an alkyl linking group (a phenyl group and a butyl linking group in this example).

### Example 5

Four polishing compositions were prepared. Each of the polishing compositions was prepared as an A pack and a corresponding B pack. The A packs included 0.43 weight percent of a ceria having a substantially cubic shape, a weight average particle size of 136 nm (measured via CPS), and a surface area of 13 m²/g. The A pack further included 3500 ppm by weight picolinic acid and had a pH of 4. The B pack included a 2000 ppm by weight of a hydroxamic acid compound and a sufficient quantity of a bis-tris buffer to buffer the pH of the B pack at pH 7. Composition 5A included benzohydroxamic acid. Composition 5B included N-hydroxy-2-phenylacetamide. Composition 5C included 4-Fluorobenzohydroxamic acid. And composition 5D included 4-Phenylbutyrl hydroxamic acid. The A pack and B pack were mixed at a 7:3 ratio prior to polishing (such that the polishing compositions included 600 ppm by weight of the corresponding hydroxamic acid compound).

The CMP performance of each of the polishing compositions was evaluated using a Mirra® CMP polishing tool (Applied Materials) with an E6088 polishing pad (Entegris) and in-situ conditioning using a Saesol DS8051 disk conditioner at 6 lbs. Trench loss and step height were evaluated by polishing 200 mm patterned wafers at a downforce of 3.0 psi, a platen speed of 100 rpm, a head speed of 85 rpm, and a slurry flow rate was 150 ml/min. The trench loss and step height were evaluated on a 100×100 μm feature (50 percent dense) after 20 seconds and 90 seconds of polishing and are shown in Table 5.

TABLE 5

| Polishing | Hydroxamic | Step Height | Trench Loss | Step Height | Trench Loss |
|---|---|---|---|---|---|
| Composition | Acid | 20 sec (Å) | 20 sec (Å) | 90 sec (Å) | 90 sec (Å) |
| 5A | BHA | 2905 | 63 | 77 | 1653 |
| 5B | PhAcHA | 3035 | 53 | 126 | 1265 |
| 5C | 4FBHA | 2943 | 55 | 207 | 714 |
| 5D | 4PhBuHA | 3101 | 33 | 441 | 338 |

As is apparent from the results set forth in table 5, polishing compositions 5B, 5C, and 5D (particularly compositions 5C and 5D) exhibited significantly reduced trench loss at 90 seconds indicating improved self-stopping performance and improved planarization efficiency. This example demonstrates the superiority of compositions in which the hydroxamic acid includes a substituted aryl group (a fluoro-substituted phenyl group in this example) or an aryl group and an alkyl linking group (a phenyl group and a butyl linking group in this example).

### Example 6

Ten polishing compositions were prepared. Each of the polishing compositions was prepared as an A pack and a corresponding B pack. The A packs included 0.43 weight percent of a ceria having a substantially cubic shape, a weight average particle size of 136 nm (measured via CPS), and a surface area of 13 m²/g. The A pack further included 3500 ppm by weight picolinic acid and had a pH of 4. The B pack included an amount of a hydroxamic acid compound equal to a molar equivalent of 3000 ppm by weight of benzohydroxamic acid. The B pack further included a sufficient quantity of a bis-tris buffer to buffer the pH of the B pack at pH 7. The hydroxamic acid compounds are listed in Table 6A (see also FIGS. 1-4). The A pack and B pack were mixed at a 7:3 ratio prior to polishing (such that the polishing compositions the molar equivalent of 600 ppm of benzohydroxamic acid).

The CMP performance of each of the polishing compositions was evaluated using a Mirra® CMP polishing tool (Applied Materials) with an E6088 polishing pad (Entegris) and in-situ conditioning using a Saesol DS8051 disk conditioner at 6 lbs. Polishing removal rates were obtained by polishing 200 mm blanket and patterned TEOS wafers at a downforce of 3.0 psi, a platen speed of 100 rpm, a head speed of 85 rpm, and a slurry flow rate was 150 mL/min. Blanket wafer and patterned wafer polishing rates are shown in Table 6B. The patterned wafer rates are reported for 100×100 μm and 900×900 μm line features.

TABLE 6A

| Polishing Composition | Hydroxamic Acid | Concentration (mM) - (ppm) |
|---|---|---|
| 6A | BHA | 6.58-900 |
| 6B | 2FBHA | 3.29-509 |
| 6C | 2FBHA | 6.58-1018 |
| 6D | 3FBHA | 3.29-509 |
| 6E | 3FBHA | 6.58-1018 |
| 6F | 4FBHA | 3.29-509 |
| 6G | 4FBHA | 6.58-1018 |
| 6H | 4MeBHA | 3.29-496 |
| 6I | 4MeBHA | 6.58-892 |
| 6J | 4PhBuHA | 1.65-294 |

TABLE 6B

| | | Pattern Rate | Pattern Rate |
|---|---|---|---|
| Polishing | Blanket Rate | 100 × 100 μm | 900 × 900 μm |
| Composition | (Å/min) | (Å/min) | (Å/min) |
| 6A | 1455 | 6904 | 3836 |
| 6B | 2084 | 6893 | 4300 |
| 6C | 648 | 7054 | 3753 |
| 6D | 1404 | 6971 | 4280 |
| 6E | 537 | 6721 | 3429 |
| 6F | 1498 | 7098 | 4210 |
| 6G | 630 | 6969 | 3723 |
| 6H | 1431 | 7642 | 4155 |
| 6I | 643 | 7730 | 3926 |
| 6J | 1495 | 6699 | 4168 |

As is evident from the data set forth in table 6B, polishing compositions 6C, 6E, 6G, and 6I exhibit lower blanket rates while maintaining comparably high pattern rates as compared to polishing composition 6A, thereby indicating an improvement in the self-stop polishing performance with these alkyl- or halide-substituted aryl hydroxamic acids. Additionally, the hydroxamic acid compounds in compositions 6B, 6D, 6F, and 6H are present at just half the molar amount compared to compound 6A, and all except 6B show an improved self-stop performance versus 6A, as indicated by similar blanket and pattern removal rate values. Preferred composition 6J enables equal self-stop performance (comparable low blanket RR and high pattern RR) to 6A while using only one-fourth the molar amount of the hydroxamic acid compound.

### Example 7

The aqueous solubility was measured and the partition coefficient was computed for nineteen hydroxamic acid compounds. To measure the aqueous solubility, a supersaturated solution of each hydroxamic acid compound was prepared in deionized water. The pH was adjusted to 5.5 using nitric acid and the supersaturated solution was stirred overnight. Excess solids were removed via filtration and the hydroxamic acid compound in solution was quantified using ¹H NMR with a t-BuOH standard. No significant impurities were observed for any of the hydroxamic acid compounds tested. It was not possible to achieve super saturation for the 2FurHA compound. The actual solubility was greater than the 17.8% that is reported herein. The partition coefficients were computed using the procedure described in Wildman, Scott A. and Crippen, Gordon M., Prediction of Physicochemical Parameters by Atomic Contributions, J. Chem. Inf. Comput. Sci. 1999, 39, 5, 868-873. Briefly, an atom type classification system was used for an atom-based calculation of the partition coefficient (log P) and the molar refractivity (MR). The hydroxamic acid compounds and the corresponding aqueous solubility and partition coefficient are listed in table 7.

TABLE 7

| Hydroxamic Acid | Aqueous Solubility | Partition Coefficient |
|---|---|---|
| 2PicHA | 3.0% | 0.2 |
| 2FurHA | >17.8% | 0.4 |
| BzOAcHA | 1.8% | 0.7 |
| PhACHA | 1.5% | 0.7 |
| 4CNPhHA | 0.5% | 0.7 |
| BHA | 3.6% | 0.8 |
| 2MeOBHA | 1.1% | 0.8 |
| 4MeOBHA | 0.4% | 0.8 |
| 3FBHA | 1.3% | 0.9 |
| 4FBHA | 1.0% | 0.9 |
| 2FBHA | 1.0% | 0.9 |
| HexHA | 4.8% | 1.1 |
| 2MeBHA | 3.3% | 1.1 |
| 4MeBHA | 0.5% | 1.1 |
| CinHA | 0.6% | 1.2 |
| 4PhBuHA | 1.6% | 1.5 |
| 4pAnisBuHA | 0.5% | 1.5 |
| 4pTolBuHA | 0.2% | 1.8 |
| OctHA | 0.2% | 1.9 |

It will be understood that the recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A chemical mechanical polishing composition comprising:
a liquid carrier;
ceria particles dispersed in the liquid carrier; and
a hydroxamic acid compound including a non-cyclic alkyl group having from three to ten carbon atoms.

2. The composition of claim 1, wherein the noncyclic alkyl group comprises from 6 to 10 carbon atoms.

3. The composition of claim 2, wherein the noncyclic alkyl group comprises a straight-chain, saturated alkyl group.

4. A chemical mechanical polishing composition comprising:
a liquid carrier;
ceria particles dispersed in the liquid carrier; and
a hydroxamic acid compound including a halide- or alkyl-substituted aryl group.

5. The composition of claim 4, wherein the halide- or alkyl-substituted aryl group comprises a fluoro-substituted phenyl group.

6. The composition of claim 4, wherein the halide- or alkyl-substituted aryl group comprises a methyl-substituted phenyl group.

7. The composition of claim 4, wherein the hydroxamic acid compound further comprises an alkyl linking group having from 2 to 6 carbon atoms, the alkyl linking group coupling the halide- or alkyl-substituted aryl group to a hydroxamic acid group.

8. The composition of claim 4, wherein the hydroxamic acid compound comprises fluorobenzo hydroxamic acid, methylbenzo hydroxamic acid, or a mixture thereof.

9. A chemical mechanical polishing composition comprising:
a liquid carrier;
ceria particles dispersed in the liquid carrier; and
a hydroxamic acid compound including an aryl group or a substituted aryl group and an alkyl linking group coupling the aryl group or substituted aryl group to a hydroxamic acid group.

10. The composition of claim 9, wherein:
the alkyl linking group is a straight-chain alkyl group comprising from 3 to 6 carbon atoms.

11. The composition of claim 9, wherein the substituted aryl group comprises a methyl-substituted aryl group, a methoxy-substituted aryl group, or a fluoro-substituted aryl group.

12. The composition of claim 9, wherein the aryl group or the substituted aryl group comprises a phenyl group or a substituted phenyl group.

13. The composition of claim 12, wherein the phenyl group or the substituted phenyl group comprises a methyl-substituted phenyl group, a methoxy-substituted phenyl group, or a fluoro-substituted phenyl group.

14. The composition of claim 9, wherein the hydroxamic acid compound comprises 4-phenylbutyrl hydroxamic acid, 4-(p-anisyl)butyrohydroxamic acid, 4-(p-tolyl) butyrohydroxamic acid, cinnamohydroxamic acid (CinHA), or a mixture thereof.

15. The composition of claim 1, wherein the hydroxamic acid compound has a partition coefficient of at least 0.9.

16. The composition of claim 1, wherein the hydroxamic acid compound has an aqueous solubility of at least about 0.2%.

17. The composition of claim 1, comprising from about 0.1 wt. % to about 10 wt. % of the ceria particles at point of use.

18. The composition of claim 1, comprising from about 1 ppm to about 5000 ppm of the hydroxamic acid compound at point of use.

19. The composition of claim 1, having a pH in a range from about 4 to about 9 at point of use.

20. The composition of claim 1, further comprising at least one of picolinic acid and a cationic polymer.
